(19) United States
(12) Patent Application Publication
(10) Pub. No.: US 2018/0227501 A1
(43) Pub. Date: Aug. 9, 2018

(54) MULTIPLE VANTAGE POINT VIEWING PLATFORM AND USER INTERFACE

(71) Applicant: Livestage, Inc., New York, NY (US)

(72) Inventor: Kristopher King, Hermosa Beach, CA (US)

(73) Assignee: Livestage, Inc., New York, NY (US)

(21) Appl. No.: 15/943,471

(22) Filed: Apr. 2, 2018

Related U.S. Application Data
(63) Continuation-in-part of application No. 14/941,582, filed on Nov. 14, 2015.
Application No. 14/941,582 is a continuation of application No. 14/719,636, filed on May 22, 2015.
Application No. 14/719,636 is a continuation of application No. 14/689,922, filed on Apr. 17, 2015, now abandoned.
Application No. 14/689,922 is a continuation of application No. 14/687,752, filed on Apr. 15, 2015, now abandoned.
Application No. 14/687,752 is a continuation of application No. 14/532,659, filed on Nov. 4, 2014, now abandoned.
Application No. 14/532,659 is a continuation-in-part of application No. 14/941,584, filed on Nov. 14, 2015.
Application No. 14/941,584 is a continuation-in-part of application No. 14/754,432, filed on Jun. 29, 2015.
Application No. 14/754,432 is a continuation-in-part of application No. 14/754,446, filed on Jun. 29, 2015.
Application No. 14/754,446 is a continuation-in-part of application No. 14/096,869, filed on Dec. 4, 2013, now abandoned.
(60) Provisional application No. 61/900,093, filed on Nov. 5, 2013.
(60) Provisional application No. 61/981,416, filed on Apr. 18, 2014.
(60) Provisional application No. 61/981,817, filed on Apr. 20, 2014.
(60) Provisional application No. 62/002,656, filed on May 23, 2014.
(60) Provisional application No. 62/080,386, filed on Nov. 16, 2014.
(60) Provisional application No. 62/080,381, filed on Nov. 16, 2014.
(60) Provisional application No. 62/018,853, filed on Jun. 30, 2014.
(60) Provisional application No. 62/019,017, filed on Jun. 30, 2014.

(51) Int. Cl. H04N 5/247; G11B 27/10; H04S 7/00; H04N 7/06; G11B 27/031; H04N 5/222; H04N 5/232

(52) U.S. Cl. CPC H04N 5/247; G11B 27/10; H04S 7/302; H04N 5/23238; G11B 27/031; H04N 5/222; H04S 2400/15; H04N 7/066

(57) ABSTRACT

The present invention provides methods and apparatus for generating and transmitting a multimedia, multi-vantage point platform for viewing audio and video data.

### FIELD OF THE INVENTION

The present invention relates to methods and apparatus for generating streaming video captured from multiple vantage points. More specifically, the present invention presents methods an apparatus for capturing image data in two dimensional or three dimensional data formats and from multiple disparate points of capture, and assembling the captured image data into a viewing experience emulating observance of an event from at least two of the multiple points of capture.

### BACKGROUND OF THE INVENTION

Traditional methods of viewing image data generally include viewing a video stream of images in a sequential format. The viewer is presented with image data from a single vantage point at a time. Simple video includes streaming of imagery captured from a single image data capture device, such as a video camera. More sophisticated productions include sequential viewing of image data captured from more than one vantage point and may include viewing image data captured from more than one image data capture device.

As video capture has proliferated, popular video viewing forums, such as YouTube™, to allow for users to choose from a variety of video segments. In many cases, a single event will be captured on video by more than one user and each user will post a video segment on YouTube. Consequently, it is possible for a viewer to view a single event from different vantage points, However, in each instance of the prior art, a viewer must watch a video segment from the perspective of the video capture device, and cannot switch between views in a synchronized fashion during video replay.

Consequently, alternative ways of viewing captured image data that allow for greater control by a viewer are desirable.

### SUMMARY OF THE INVENTION

Accordingly, the present invention provides methods and apparatus for capturing image data from multiple vantage points and making the image data available across a distributed platform in a synchronized manner to a user via one or both of an interactive user interface and a predetermined sequence of video segments.

The image data captured from multiple vantage points may be captured as one or both of: two dimensional image data or three dimensional image data. The data is synchronized such that a user may view image data from multiple vantage points, each vantage point being associated with a disparate image capture device. The data is synchronized such that the user may view image data of an event or subject at an instance in time, or during a specific time sequence, from one or more vantage points.

In some embodiments, a user may view multiple image capture sequences at once on a multi view interface pane. In additional embodiments, a user may sequentially choose one or multiple vantage points at a time. In still other embodiments, a user may view a sequence of video image data segments compiled by another user or “user producer,” such that the artistic preferences of amateur or professional users may be shared with other users.

Still further embodiments allow for multiple segments of image data to be combined with one or more of: unassociated images, unassociated video segments and editorial content to generate a hybrid of event imagery and external imagery. Unassociated images, unassociated video segments and editorial content to generate a hybrid of event imagery and external imagery may be combined for example with a device including a processor running executable software and a viewing screen with a graphical user interface (“GUI”).

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a block diagram of Content Delivery Workflow according to some embodiments of the present invention.

FIG. 2 illustrates a block diagram of Live Production Workflow according to some embodiments of the present invention.

FIG. 3 illustrates an exemplary user interface according to some embodiments of the present invention.

FIG. 4 illustrates additional features of an exemplary user interface according to some embodiments of the present invention.

FIG. 5 illustrates a controller that may be used in some embodiments of the present invention.

### DETAILED DESCRIPTION

The present invention provides generally for the use of multiple camera arrays for the capture and processing of image data that may be used to generate visualizations of live performance imagery from a multi-perspective reference. More specifically, the visualizations of the live performance imagery can include oblique and/or orthogonal approaching and departing view perspectives for a performance setting. Image data captured via the multiple camera arrays is synchronized and made available to a user via a communications network. The user may choose a viewing vantage point from the multiple camera arrays for a particular instance of time or time segment.

In the following sections, detailed descriptions of embodiments and methods of the invention will be given. The description of both preferred and alternative embodiments though through are exemplary only, and it is understood that to those skilled in the art that variations, modifications and alterations may be apparent. It is therefore to be understood that the exemplary embodiments do not limit the broadness of the aspects of the underlying invention as defined by the claims.

### Definitions

As used herein “Broadcast Truck” refers to a vehicle transportable from a first location to a second location with electronic equipment capable of transmitting captured image data, audio data and video data in an electronic format, wherein the transmission is to a location remote from the location of the Broadcast Truck.

As used herein, “Image Capture Device” refers to apparatus for capturing digital image data, an Image capture device may be one or both of: a two dimensional camera (sometimes referred to as “2D”) or a three dimensional camera (sometimes referred to as “3D”). In some exemplary embodiments an image capture device includes a charged coupled device (“CCD”) camera.

As used herein, Production Media Ingest refers to the collection of image data and input of image data into a storage for processing, such as Transcoding and Caching. Production Media Ingest may also include the collection of associated data, such a time sequence, a direction of image capture, a viewing angle, 2D or 3D image data collection.

As used herein, Vantage Point refers to a location of Image Data Capture in relation to a location of a performance.

As used herein, Directional Audio refers to audio data captured from a vantage point and from a direction such that the audio data includes at least one quality that differs from audio data captured from the vantage and a second direction or from an omni-direction capture.

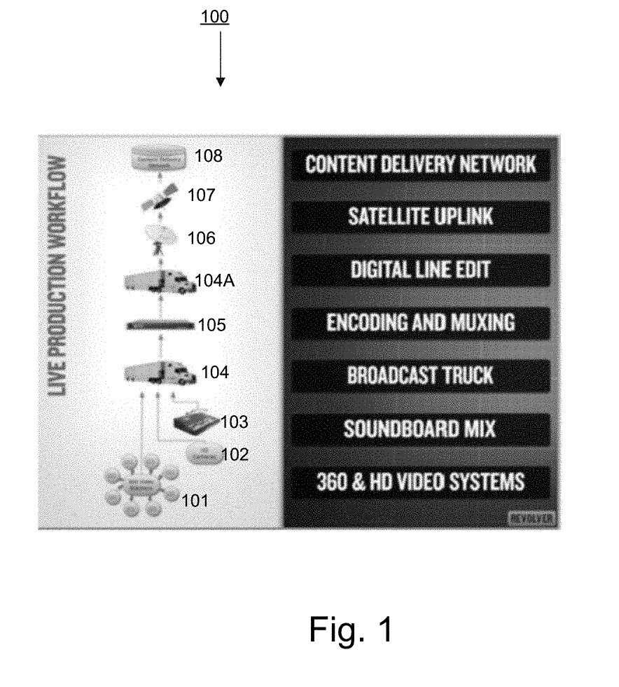

Referring now to FIG. 1, a Live Production Workflow diagram is presented 100 with components that may be used to implement various embodiments of the present invention. Image capture devices 101-102, such as for example, one or both of 360 degree camera arrays 101 and high definition camera's 102 capture image date of an event. In preferred embodiments, multiple vantage points each have both a 360 degree camera array 101 and at least one high definition camera 102 capturing image data of the event. Image capture devices 101-102 may be arranged for one or more of: planer image data capture; oblique image data capture; and perpendicular image data capture. Some embodiments may also include audio microphones to capture sound input which accompanies the captured image data.

Additional embodiments may include camera arrays with multiple viewing angles that are not complete 360 degree camera arrays, for example, in some embodiments, a camera array may include at least 120 degrees of image capture, additional embodiments include a camera array with at least 180 degrees of image capture; and still other embodiments include a camera array with at least 270 degrees of image capture. In various embodiments, image capture may include cameras arranged to capture image data in directions that are planar or oblique in relation to one another.

At 103, a soundboard mix may be used to match recorded audio data with captured image data. In some embodiments, in order to maintain synchronization, an audio mix may be latency adjusted to account for the time consumed in stitching 360 degree image signals into cohesive image presentation.

At 104, a Broadcast Truck includes audio and image data processing equipment enclosed within a transportable platform, such as, for example, a container mounted upon, or attachable to, a semi-truck, a rail car; container ship or other transportable platform. In some embodiments, a Broadcast Truck will process video signals and perform color correction. Video and audio signals may also be mastered with equipment on the Broadcast Truck to perform on-demand post-production processes.

At 105, in some embodiments, post processing may also include one or more of: encoding; muxing and latency adjustment. By way of non-limiting example, signal based outputs of HD cameras may be encoded to predetermined player specifications. In addition, 360 degree files may also be re-encoded to a specific player specification. Accordingly, various video and audio signals may be muxed together into a single digital data stream. In some embodiments, an automated system may be utilized to perform muxing of image data and audio data.

At 104A, in some embodiments, a Broadcast Truck or other assembly of post processing equipment may be used to allow a technical director to perform line-edit decisions and pass through to a predetermined player's autopilot support for multiple camera angles.

At 106, a satellite uplink may be used to transmit post process or native image data and audio data. In some embodiments, by way of non-limiting example, a muxed signal may be transmitted via satellite uplink at or about 80 megabytes (Mb/s) by a commercial provider, such as, PSSI Global™ or Sureshot™ Transmissions.

In some venues, such as, for example events taking place at a sports arena a transmission may take place via Level 3 fiber optic lines, otherwise made available for sports broadcasting or other event broadcasting. At 107 Satellite Bandwidth may be utilized to transmit image data and audio data to a Content Delivery Network 108.

As described further below, a Content Delivery Network 108 may include a digital communications network, such as, for example, the Internet. Other network types may include a virtual private network, a cellular network, an Internet Protocol network, or other network that is able to identify a network access device and transmit data to the network access device. Transmitted data may include, by way of example: transcoded captured image data, and associated timing data or metadata.

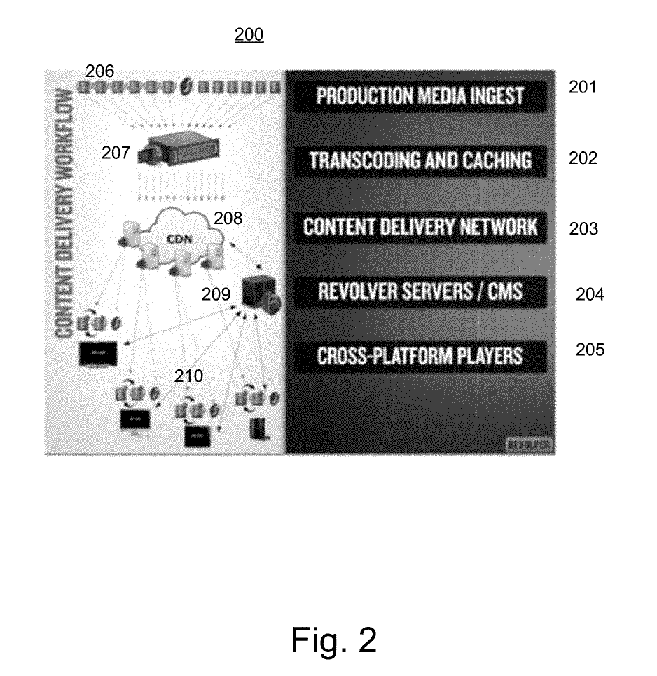

Referring now to FIG. 2, a flow chart is illustrated with components of a multi-vantage point viewing system 200 according to the present invention. Production Media Ingest 201 may be accomplished via Image Capture Devices, such as 2D or 3D cameras 206. Cameras 206 may include, for example, CCD digital cameras that capture imagery as one or both of video or image frame formats. Specific examples of Image Capture Devices include: three dimensional digital cameras, such as for example charged couple device (“CCD”) cameras, and high definition cameras which may also be digital CCD cameras. Image data may be captured in a digital format that may be proprietary or an industry standard format. High definition cameras may include 920×1080 pixel digital professional video cameras based on CCD technology, sometimes referred to as “digital cinematography”.

Production Media Ingest 201 is accomplished via multiple Image Capture Devices 206 arranged at multiple Vantage Points, wherein multiple Vantage Points may include one to both of: more than one disparate physical point of capture locations and more than one disparate point of capture viewing direction.

Production Media Ingest may also include synchronous time recordation indicating when individual image segments are captured. The synchronous time recordation may facilitate transcoding and caching 102 of image data, which in turn allows for video replay of an instance of an event from multiple perspectives, each perspective from a different vantage point.

At 202 Transcoding and Caching may include storage of image data with correlating data indicating a time and location of image data capture. Data indicating a specific time of capture may be linked to the image data in a manner that allows a user to choose from multiple image data sets. Each image data set may be associated with a disparate vantage point from which the image was captured. Uploaded video signal data may be transcoded to multiple formats and bitrates. Multiple bitrates may be used to allow an optimum viewing experience for individual users, wherein each user may use an appropriate bit rate for a bandwidth employed by different users.

A Content Delivery Network 203 may include a digital communications network, such as, for example, the Internet. Other network types may include a virtual private network, a cellular network, an Internet Protocol network, or other network that is able to identify a network access device and transmit data to the network access device. Transmitted data may include, by way of example: transcoded captured image data, and associated timing data or metadata. In some embodiments, multiple content sites may be placed at locations proximate to a destination specified by users. Some embodiments may also use forward proxy ingest to reduce storage cost on the CDN so that only image data that is “watched” is pulled.

Post processing servers 209, such as, for example one or more Revolver™ CMS Servers 209, may be utilized to organize the transmitted data and present it for viewing via one or more user network access devices 210. Cross Platform Players 205 may receive transmitted data, wherein the Cross Platform Players may include user network access devices 205 may receive data via the Content Delivery network 208, directly from the Revolver Servers 209, a cellular network, or via a private data network.

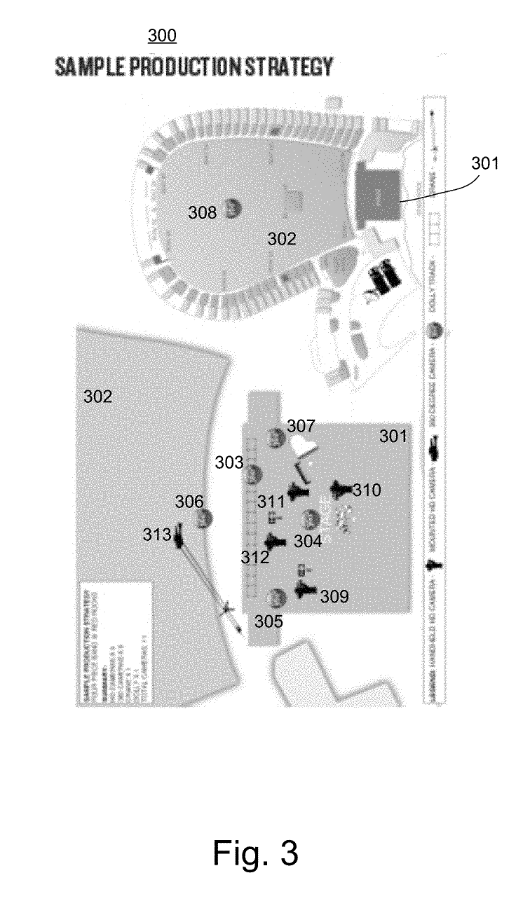

Referring now to FIG. 3, a sample video and audio production strategy is illustrated. A production area may include an event location 301, such as a stage and an audience viewing area 302. The event location 301 and the audience viewing area 302 include multiple vantage points, wherein each vantage point include one or more of a 360 degree camera arrays 303-308 and HD cameras 309-312. Audio pick-ups, such as one or more microphones 313 may also be included in the video and audio production strategy. In some embodiments, audio pickups may also be included in the 360 camera arrays, the HD cameras, or proximate to performers (not shown).

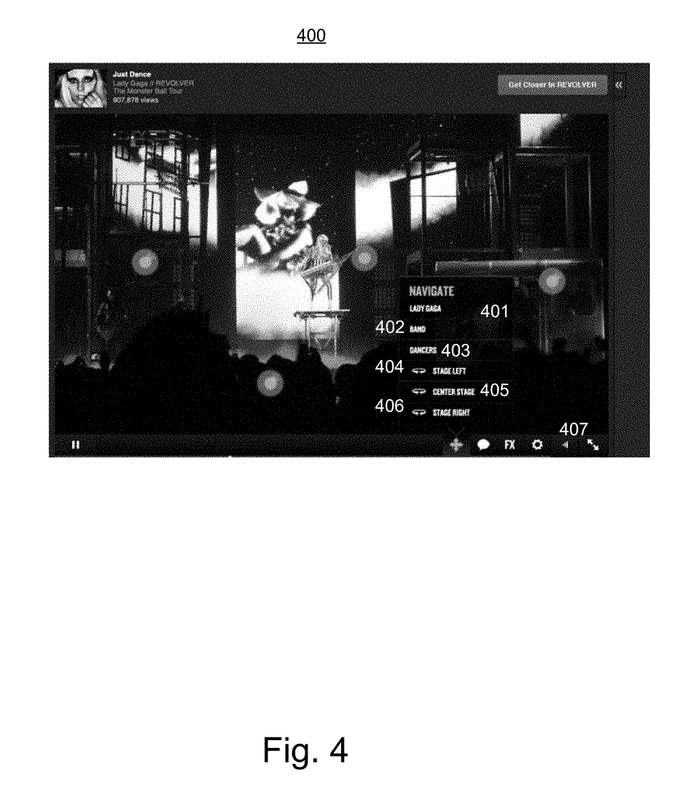

Referring now to FIG. 4, an exemplary user interface 400 is illustrated. The exemplary user interface is typically transmitted to a user's Network Access Device as digital data and displayed on a display screen. At 401 an identifier of an event, such as a performer's name is provided. An event may be anyone, or anything on which data capture is focused. By way of non-limiting example, a performer may be a music performer, a presenter, a machine, a workplace, a sporting event, a demonstration, a television show, an entertainment act, a speech, a classroom, a competition, or other subject in a time and place being recorded,

At 402-406, various Vantage Points are listed from which a user or other viewer may view captured image data. As illustrated, the event includes a band performing and Vantage Points 401-406, include various views of the band performing. By way of non-limiting example, the Vantage Points include: vie of the a main performer 401; a view of the band 402; a view of dancers 403; a view of stage left 404; a view of center stage 405; and a view of stage right 406.

In some embodiments, each Vantage Point may be associated with audio data captured in proximity to the individual Vantage Points 401-406. Audio may also include overdubbing related to what is being viewed in the image data associated with the Vantage Point. For example, overdubbing may explain who is performing and where and when. The overdubbing may also include editorial or instructional content.

User controls 407 may also be included in the User Interface 300. User controls 407, may include, for example user interactive devices that operate via software or firmware in correlation with a controller or a processor to: indicate a vantage point, indicate a direction, indicate a zoom preference, indicate a filter, and indicate a resolution such as, for example high definition or standard.

Referring now to FIG. 4, a user interface 400 is illustrated with additional user interactive controls 401-407.

The teachings of the present invention may be implemented with apparatus capable of embodying the innovative concepts described herein. Image presentation can be accomplished via multimedia type user interface. Embodiments can therefore include a personal computer, handheld, game controller; PDA, cellular device, smart device, High Definition Television or other multimedia device with user interactive controls, including, in some embodiments, voice activated interactive controls.

Apparatus

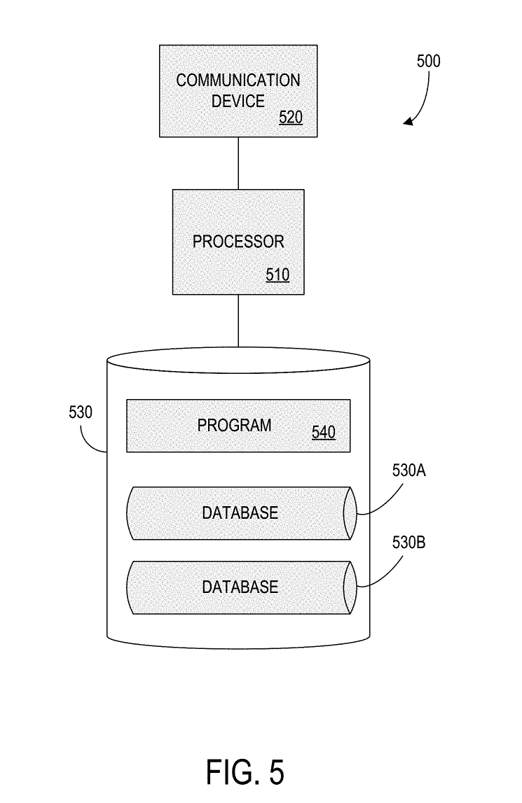

In addition, FIG. 5 illustrates a controller 500 that may be utilized to implement some embodiments of the present invention. The controller may be included in one or more of the apparatus described above, such as the Revolver Server, and the Network Access Device. The controller 500 comprises a processor unit 510, such as one or more semiconductor based processors, coupled to a communication device 520 configured to communicate via a communication network (not shown in FIG. 5). The communication device 520 may be used to communicate, for example, with one or more online devices, such as a personal computer, laptop or a handheld device.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 can store a software program 540 for controlling the processor 510. The processor 510 performs instructions of the software program 540, and thereby operates in accordance with the present invention. The processor 510 may also cause the communication device 520 to transmit information, including, in some instances, control commands to operate apparatus to implement the processes described above. The storage device 530 can additionally store related data in a database 530A and database 530B, as needed.

### Specific Examples of Equipment

Apparatus described herein may be included, for example in one or more smart devices such as, for example: a mobile phone, tablet or traditional computer such as laptop or microcomputer or an Internet ready TV.

The above described platform may be used to implement various features and systems available to users. For example, in some embodiments, a user will provide all or most navigation. Software, which is executable upon demand, may be used in conjunction with a processor to provide seamless navigation of 360/3D/panoramic video footage with Directional Audio—switching between multiple 360/3D/panoramic cameras and user will be able to experience a continuous audio and video experience.

Additional embodiments may include the system described automatic predetermined navigation amongst multiple 360/3D/panoramic cameras. Navigation may be automatic to the end user but the experience either controlled by the director or producer or some other designated staff based on their own judgment.

Still other embodiments allow a user to record a user defined sequence of image an audio content with navigation of 360/3D/panoramic video footage, Directional Audio, switching between multiple 360/3D/panoramic cameras. In some embodiments, user defined recordations may include audio, text or image data overlays. A user may thereby act as a producer with the Multi-Vantage point data, including directional video and audio data and record a User Produced multimedia segment of a performance. The User Produced may be made available via a distributed network, such as the Internet for viewers to view, and, in some embodiments further edit the multimedia segments themselves.

Directional Audio may captured via an apparatus that is located at a Vantage Point and records audio from a directional perspective, such as a directional microphone in electrical communication with an audio storage device. Other apparatus that is not directional, such as an omni directional microphone may also be used to capture and record a stream of audio data, however such data is not directional audio data. A user may be provided a choice of audio streams captured from a particular vantage point at at particular time in a sequence.

In some embodiments a User may have manual control in auto mode. The User is able to manually control by actions such as swipe or equivalent to switch between MVPs or between HD and 360.

In some additional embodiments, an Auto launch Mobile Remote App may launch as soon as video is transferred from iPad to TV using Apple Airplay. Using tools, such as, for example, Apple's Airplay technology, a user may stream a video feed from iPad or iPhone to a TV is connected to Apple TV. When a user moves the video stream to TV, automatically mobile remote application launches on iPad or iPhone is connected/synched to the system. Computer Systems may be used to displays video streams and switches seamlessly between 360/3D/Panoramic videos and High Definition (HD) videos.

In some embodiments that implement Manual control, executable software allows a user to switch between 360/3D/Panoramic video and High Definition (HD) video without interruptions to a viewing experience of the user. The user is able to switch between HD and any of the multiple vantage points coming as part of the panoramic video footage.

In some embodiments that implement Automatic control a computer implemented method (software) that allows its users to experience seamlessly navigation between 360/3D/Panoramic video and HD video. Navigation is either controlled a producer or director or a trained technician based on their own judgment.

Manual Control and Manual Control systems may be run on a portal computer such as a mobile phone, tablet or traditional computer such as laptop or microcomputer. In various embodiments, functionality may include: Panoramic Video Interactivity, Tag human and inanimate objects in panoramic video footage; interactivity for the user in tagging humans as well as inanimate objects; sharing of these tags in real time with other friends or followers in your social network/social graph; Panoramic Image Slices to provide the ability to slice images/photos out of Panoramic videos; real time processing that allows users to slice images of any size from panoramic video footage over a computer; allowing users to purchase objects or items of interest in an interactive panoramic video footage; ability to share panoramic images slides from panoramic videos via email, sms (smart message service) or through social networks; share or send panoramic images to other users of a similar application or via the use of SMS, email, and social network sharing; ability to “tag” human and inanimate objects within Panoramic Image slices; real time “tagging” of human and inanimate objects in the panoramic image; allowing users to purchase objects or items of interest in an interactive panoramic video footage; content and commerce layer on top of the video footage—that recognizes objects that are already tagged for purchase or adding to user's wish list; ability to compare footage from various camera sources in real time; real time comparison panoramic video footage from multiple cameras captured by multiple users or otherwise to identify the best footage based on aspects such as visual clarity, audio clarity, lighting, focus and other details; recognition of unique users based on the user's devices that are used for capturing the video footage (brand, model #, MAC address, IP address, etc); radar navigation of which camera footage is being displayed on the screens amongst many other sources of camera feeds; navigation matrix of panoramic video viewports that in a particular geographic location or venue; user generated content that can be embedded on top of the panoramic video that maps exactly to the time codes of video feeds; time code mapping done between production quality video feed and user generated video feeds; user interactivity with the ability to remotely vote for a song or an act/song while watching a panoramic video and effect outcome at venue. Software allows for interactivity on the user front and also ability to aggregate the feedback in a backend platform that is accessible by individuals who can act on the interactive data; ability to offer “bidding” capability to panoramic video audience over a computer network, bidding will have aspects of gamification wherein results may be based on multiple user participation (triggers based on conditions such # of bids, type of bids, timing); Heads Up Display (HUD) with a display that identifies animate and inanimate objects in the live video feed wherein identification may be tracked at an end server and associated data made available to front end clients.

### Specific Examples of User Interface Functionality

In some embodiments, a player according to the present invention includes a Panoramic HTML5 Video Player, or other standardized player, referred to herein as a “KingPlaya”. KingPlaya is developed as an alternative to traditional Flash and video processing intensive panoramic players previously known in the industry.

KingPlaya may include a video processing configuration and a jquery javascript library. When multiple camera elements are stitched into a single two dimensional (2D) panoramic image, without a KingPlaya video configuration, processor intensive video processing is required to recreate the image in the player, such as stitch a far right hand edge of a first frame to a far left hand edge of a second frame of a panoramic image in a repeated fashion.

The present invention stitches multiple or all camera elements thereby creating a digital seam. The difference being that a stitch/seam that is created according to the present invention and control can be reassembled in the player without having to process any video whatsoever as it is a clean vertical line break. The video configuration sections of this document will address this in more detail.

A second element to KingPlaya may include a jquery implementation. This implementation is dependent on the above video configuration as that configuration allows the video to be reassembled with minimal to no processing. KingPlaya then duplicates the video into two identical frames sitting side by side in an A-B configuration which seam flawlessly. As the user navigates the 360 degree video, the A-B configuration is constantly re-evaluated by a return function in the jquery draggable code. KingPlaya constantly asks itself if an AB configuration or a BA configuration is more appropriate depending on the direction in which the user is moving the panoramic image. KingPlaya then rearranges the A-B or B-A configuration in real-time so that by the time the user reaches the frame edge of either the A or B frame (depending on which is currently in the viewport), the alternative frame is already aligned and the user can continue panning. This process may be repeated in either direction technical limitation.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

1. Apparatus for capturing audio and video data of an event from multiple vantage points, the apparatus comprising:
multiple arrays of image capture devices deployed at multiple vantage points in relation to an event subject location;
one or more high definition cameras deployed in at least one vantage point in relation to an event subject location; and
a content delivery network for transmitting image data captured by the multiple arrays of image capture devices with no artificial delay in transmission, said transmission being made available via an Internet Protocol network.

2. The apparatus of claim 1 additionally comprising apparatus for muxing image data captured by the multiple image data devices and the one or more high definition cameras, wherein the content delivery network transmits muxed image data.

3. The apparatus of claim 2 additionally comprising a satellite uplink for transmitting the muxed image data.

4. The apparatus of claim 3 wherein the multiple arrays of image capture devices comprise three or more cameras arranged to capture image data in 360 degrees from respective multiple vantage points in relation to the event subject location.

5. The apparatus of claim 3 wherein the image capture devices comprise digital cameras.

6. The apparatus of claim 3 wherein the high definition camera comprises 920×1080 pixel digital video cameras based on CCD technology.

7. The apparatus of claim 3 wherein the multiple vantage points comprises more than one disparate physical point of image capture at a venue.

8. The apparatus of claim 3 wherein the image capture devices are positioned to capture image data in more than one disparate viewing direction.

9. The apparatus of claim 3 additionally comprising editorial apparatus for combining images not captured by the one or more image data capture devices with captured image data.

10. The apparatus of claim 3 additionally comprising a motor vehicle transportable from a first location to a second location with electronic equipment capable of transmitting captured image data, audio data and video data in an electronic format, wherein the transmission is to a location remote from the location of the Broadcast Truck.

11. The apparatus of claim 3 additionally comprising apparatus for capturing audio data captured from a vantage point and from a direction such that the audio data includes at least one quality that differs from audio data captured from the vantage and a second direction or from an omni-direction.

12. The apparatus of claim 3 wherein the image capture devices are arranged to capture image data at an angle oblique to event subject location.

13. The apparatus of claim 3 wherein the image capture devices are arranged to capture image data at an angle perpendicular to event subject location.

14. The apparatus of claim 3 wherein the image capture devices are arranged to capture image data at an angle planar to event subject location.

15. The apparatus of claim 3 wherein the image capture devices are arranged to capture image data at angles of between about 120 degree arcs and 270 degree arcs.

16. The apparatus of claim 3 wherein the image capture devices are arranged to capture image data at angles of between about 270 degree arcs and 360 degree arcs.

17. The apparatus of claim 4 additionally comprising a processor for stitching image data into a cohesive image data presentation.

18. The apparatus of claim 17 additionally comprising a soundboard mixer synchronizing audio data with image data.

19. The apparatus of claim 18 wherein the processor and the soundboard mixer are enclosed within a transportable platform.

20. The apparatus of claim 19 wherein the transportable platform comprises a container attachable to a semi-truck.
